(19) United States
(12) Patent Application Publication
(10) Pub. No.: US 2007/0131638 A1
(43) Pub. Date: Jun. 14, 2007

(54) Simplified insulated bottle

(76) Inventor: Mahesh Thadani, Pune (IN)

Correspondence Address: Mahesh Thadani, 1, Krishna Niwas #1 , Pudumjee Compound, Pune, Maharashtra, 411042, IN

(21) Appl. No.: 10/575,277

(22) PCT Filed: Dec. 10, 2003
(86) PCT No.: PCT/IN03/00386

§ 371 Date: Apr. 9, 2006

(30) Foreign Application Priority Data
Oct. 20, 2003 (IN) 1103/MUM/2003

(51) Int. Cl. A47J 41/02; A47J 41/00; B65D 23/00

(52) U.S. Cl. 215/12.1; 215/13.1

(57) ABSTRACT

A simplified, Insulated Bottle (5), characterized by the combination of a portable, rigid polymer, standable Receptacle enclosing an adapted, removable, reusable, closure-capped polymer Bottle, said Receptacle comprising a single walled, cylindric, hollow, first end open, second end closed, integrally ribbed inwardly vertically, outer formed Body (8), united with an adapted, hollow, single walled, flat based, shorter Upper Cup (9), said Bottle being a blow moulded, narrow neck threaded, horizontally outwardly ribbed Bottle (6) closed with an adapted, top flat, reusable, threaded Closure Cap (7), said closure capped Bottle being stored in a standing, base (12) resting, body (11) mostly spaces apart, top (15) kept down by said Body secured said Upper Cup, horizontal movement restrained manner, said Bottle's maximum external width (14) being less than least internal widths (19) (23) of said Body and said Upper Cup, said Receptacle being fully opaque with incorporated or applied reflectivity or, fully clear, said Body taking alternatively to said Bottle's base to upright body end, an upright, standard 12 oz can (26), said Receptacle alternatively taking within its inner height limits, an upright can of width similar to said 12 oz can but taller (27).

### TECHNICAL FIELD

The present invention generally relates to the combination of a Bottle and an insulatory Receptacle for it, and more particularly, is concerned with a reusable polymer Bottle closed with a threaded Closure Cap and stored removably within a rigid, portable, standible Receptacle in a base resting, body mostly spaced apart, kept down by top of secured Closure Cap manner, and where the accessed Bottle, while within Receptacle's Body, can be lifted out and put back without any holding back from storing Body.

### BACKGROUND ART

Drinking water for personal use is now carried in plastic bottles. Since a thin walled bottle containing cold water will reach ambient temperature quickly, the PRIOR ART had developed various types of Bottles along with insulative Covers made from flexible sheet material or covering Holders made from expanded Polystyrene. My application 133/MUM/2003 a.k.a. PCT/IN 03/00045 was for a sturdy, single hand held Insulated Bottle wherein the threaded, circular closure capped Bottle was openable without removal from and without rotating within its effective, rigid, holding Receptacle. To drink, this style entailed lifting up enclosing Receptacle along with Bottle. This is not convenient for elderly people, nor, always seen to be correct. There is a need for a standable, rigid, insulatory Receptacle having a Body from which the Bottle can be lifted out and put back without any restraint.

### DISCLOSURE OF THE INVENTION

The object of the present invention is to provide a simplified, reusable, Insulated Bottle Device for containing liquids, characterized by a reusable, polymer Bottle of varied wall thickness being closed with a threaded, circular Closure Cap and then enclosed within a rigid, portable, standable, insulatory Receptacle in a base resting, body mostly spaced apart, kept down by top of secured Closure Cap, horizontal movement restrained manner, and where the maximum external width of the stored Bottle is less than the least internal width of the storing Receptacle, and the shoulder and neck of the stored Bottle are above the accessed open end of the Body of the storing Receptacle, so that the seated Bottle can be lifted out conveniently while mostly within the Receptacle's Body. It is an alternative use objective of the Device that instead of the Bottle body, the Body of the Receptacle is able to take an upright, standard 12 oz beverage can or, instead of the Bottle, the Receptacle is able to take a taller can of width similar to a 12 oz can. With the 12 oz can, a limited amount of ice cubes can be carried.

It is a first objective of the invention that the Device has the fewest parts possible within the framework of minimum performance required from the Device.

It is a second objective of the invention that the varied wall thickness Bottle is securely contained within the assembled Receptacle by utilizing the Bottle's stronger and thickest wall portions as seating and restricting points.

It is another objective of the invention that the Receptacle Body accepts and seats the Bottle without gripping it and also leaves the Bottle's closure capped, thick, narrow neck and. stronger shoulder outside Body's open end, so allowing the Body seated Bottle to be easily lifted out and put back without gripping the Bottle's thinner body.

Another objective of this invention is that even though the Receptacle is mostly spaced apart from stored Bottle and the stored Bottle is not gripped by the rigid Body, the Receptacle's Body's inner and the Bottle's shape coordinate to restrain the horizontal movement of stored Bottle.

In a further objective of the invention, the single walled Receptacle is made fully opaque with incorporated reflectivity to minimize outdoor heat absorption or fully clear for indoor use and circular viewing.

Briefly, the invention provides a simplified Insulated Bottle, characterized by the coordinated combination of an insulatory, portable, rigid polymer, two components united but separable, standable, Receptacle enclosingly storing an adapted, removable, reusable, closure capped, polymer Bottle. The Receptacle comprises a single walled, cylindric, hollow, first end open, second end closed, integrally ribbed inwardly and vertically, outer formed, Body united with an adapted, single walled, flat based, hollow, shorter Upper Cup. The Bottle consists of a blow moulded, hollow, varied wall thickness, narrow neck externally threaded, horizontally outwardly ribbed Bottle closed with an adapted, top flat, reusable, threaded Closure Cap. The Bottle's maximum external width is less than the least internal width of storing Body and Upper Cup. When stored, the Bottle's base rests on the inner base of the Receptacle Body and the Body secured Upper Cup inner base holds down upon the top of the stored Bottle secured Closure Cap. The Receptacle is mostly spaced apart from the stored Bottle and the Bottle's horizontal movement is restrained. The Receptacle is fully opaque with incorporated or applied reflectivity or, fully clear. The Body will take alternatively to the base and body of the Bottle, an upright standard 12 oz can, and alternatively to the Bottle, the Receptacle will take within its inner height limits, a can of width similar to the 12 oz can but taller.

### BRIEF DESCRIPTION OF DRAWINGS

FIG. 1 is a longitudinal, sectional view of the Device showing its components.

FIG. 2 is a cross sectional, downwards direction view of Bottle within spaced apart Body on line 2-2 of FIG. 1.

FIG. 3 shows the first alternative use of the Receptacle, with a standard 12 oz beverage can within the longitudinal, sectional view of the Receptacle.

FIG. 4 shows the second alternative use of the Receptacle, showing a taller can within the longitudinal, sectional view of the Receptacle.

### DETAILED DESCRIPTION OF DRAWINGS

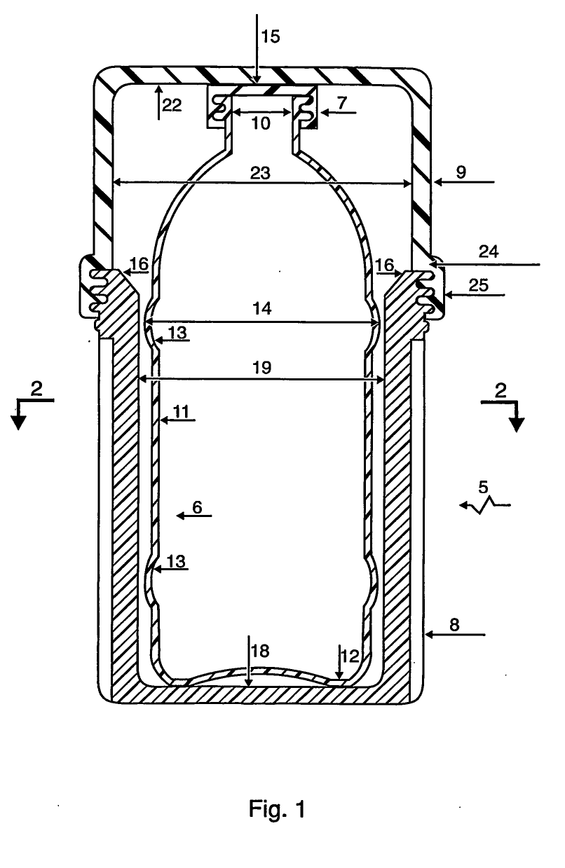

FIG. 1 denotes the Device by the numeral 5, and the components of the Device, as shown in FIG. 1 are:

| | | |
|---|---|---|
| a) | The Bottle | 6. |
| b) | The Closure Cap | 7. |
| c) | The Body | 8. |
| d) | The Upper Cup | 9. |

The Device has two major components, the Receptacle that will store the closed Bottle, and the closure capped Bottle, which will contain the liquids. The Bottle 6 with self secured Closure Cap 7 forms the closure capped Bottle and assembling the Body 8 with its adapted Upper Cup 9 forms the Receptacle.

The upright, circular, externally threaded, thickest, open neck end of Bottle 6 takes circular, internally threaded Closure Cap 7. Closure capped Bottle 6 (+7) has to be seated in Body 8, and then Upper Cup 9 has to be mated with Body 8 to form the insulatory Receptacle. The stored Bottle is removable and reusable.

The Bottle 6 is made from Polyethylene Terepthalate [PET]. A PET bottle with a circular, externally threaded open neck end is machine blown from a smaller, injection moulded preform of the same material, wherein the perform already has external threads moulded on its open end's outer, such threads subsequently becoming the external threads of open neck of formed bottle. When a PET preform is heated, stretched and blown into a bottle shape, the bottle wall thickness varies; to avoid confusion, the drawings do not show this variance. In the drawings, the wall thickness of the Bottle is shown as uniform, even though practically, this will not be so. Actually, the formed Bottle's neck portion will be the thickest, followed by a less thick shoulder portion and a thinner body portion. The base portion will be stronger than the body portion. These are all used in the Device concept. Also, the Bottle is made from a much heavier perform than is normally used for a similar size PET bottle so as to give a sturdy, long life bottle.

The formed Bottle 6 has a first upright, circular, narrow, externally threaded, thickest, open end neck portion 10, a neck downwards depending, gradually widening shoulder portion, a shoulder end depending, downwards, ribbed body portion 11, with a body end closed base portion 12. 13 shows the horizontal outward ribs on the Bottle's upright body portion. 14 shows the maximum external width of the Bottle. The Bottle 6 will contain within itself, the required cold water. For secure closing, the open neck end 10 has external threads to take the adapted, circular, internally threaded, non-permanently fixed, removable and reusable Closure Cap 7.

Closure Cap 7 has a top flat circular portion with a depending downwards skirt internally threaded. Closure Cap 7 is commonly known as a ‘single piece’ cap. 15 shows the top flat of the Closure Cap 7. This is the place that will be held down by the Body secured Upper Cup's inner base to hold fast the stored Bottle within the formed Receptacle. The Receptacle Body 8 will seat and hold the body of Bottle 6. The Body 8 is a single walled, cylindric, hollow, first end open, second end closed, ribbed inwardly vertically, formed outer, injection moulded, rigid polymer form.

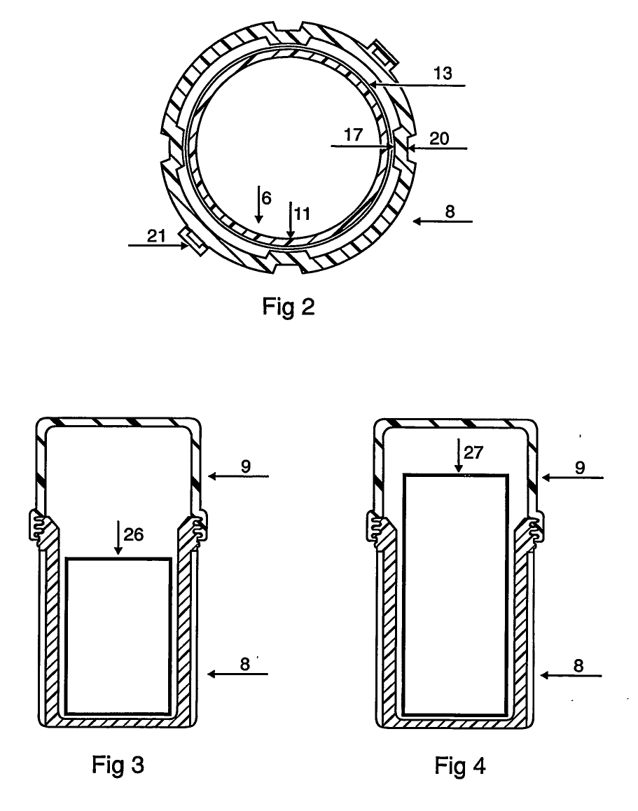

The Body 8 will accept, seat and enclose within itself, the Bottle's base 12 and upright body portion 11, leaving the Bottle's shoulder and neck outside itself, as shown in FIG. 1. 16 (FIG. 1) shows the first open end of the Body, and 17 (FIG. 2), the Body's integral, inward, vertical, ribs. 18 (FIG. 1) shows the inner base of the Body on which the base 12 of the stored Bottle will rest. 19 (FIG. 1) shows the least internal width of the Body, this being as across opposite ribs opposite sides. 20 (FIG. 2), shows the outer grooves on Body that, provide an improved grip while opening or closing the Receptacle. 21 (FIG. 2) shows the strap holding place on Body outer. FIG. 1 shows that the maximum external width 14 of Bottle 6 is less than the least internal width 19 of Body 8.

When Bottle 6 is seated in Body 8, with Bottle base 12 resting on Body base inner 18, the upright body portion 11 and base 12 of Bottle 6 will not be held back by inner form of Body 8. Thus, closure capped stored Bottle 6 (+7) can be gripped by its narrow neck and removed from storing Body through Body's open end 16.

FIG. 1 also shows the Upper Cup's base's inner flat side 22. 23 shows the least internal width of the upper Cup, which, is also more than the maximum external width 14 of the Bottle 6. 24 shows the outward, horizontal, flat ring part of the Upper Cup. 25 show the flat ring end, downward depending, internally threaded skirt.

FIG. 2 is a cross sectional, downwards direction view of the seated Bottle 6 within spaced apart Body 8, at a level as shown by the line 2-2 in FIG. 1. FIG. 2 shows the combinational result of the Body inner ribs 17 and the Bottle outer ribs 13, wherein most of the inner of the storing Body becomes spaced apart from the stored Bottle. FIG. 2 also shows that although the Body is mostly spaced apart from stored bottle, the two sets of ribs restrain the horizontal movement of the stored Bottle 6 in Body 8.

FIG. 3 shows the first alternative use of the Receptacle, wherein instead of the Bottle base to body, the Body 8 will take a standard 12 oz beverage can (26).

FIG. 4 shows the second alternative use of the Receptacle, wherein instead of the Bottle, the Receptacle will take a taller can (27) of width similar to that of a 12 oz can.

The Body's top has outer threads and the Upper Cup skirt has adapted internal threads. Since Body 8 and Upper Cup 9 are hollow, single walled, injection moulded shapes, they can be made fully opaque with incorporated or applied reflectivity or, fully clear. When opaque, this is done by adding suitable material to the production process or by the application of a reflective film, resin, metal or polymer on its surface. The Body can be held by a strap or clip attached to attachment point 21 (FIG. 2) or by an integrated handle. The strap can take a nametag to show owner of Device. When the Receptacle is clear, circular external viewing of stored Bottle and Bottle enclosed water is possible.

For use, the Bottle 6 is filled with cold water and closed with Closure Cap 7. Bottle 6 (+7), filled and capped, is then placed in Body 8, with Bottle base downwards until Bottle base 12 is sitting on Body's base inner 18. Once the Bottle is seated within Body, the internally threaded skirt of the Upper Cup is secured onto the threads on Body outer to complete the Receptacle form. During such securing, the Upper Cup's base's inner flat side 22 will come and kissingly rest on 15, the top flat of the Bottle secured Closure Cap.

To drink water from Receptacle stored Bottle, the Upper Cup is separated from Body. This gives access to stored Bottle's neck and shoulder. The stored Bottle can be lifted out from Body, water can be drunk, the Bottle put back, and the Upper Cup resecured to Body. Since the Receptacle is standable, it can be kept on the level surface of a Desk.

1. A simplified Insulated Bottle, characterized by the combination of a portable, rigid polymer, standable Receptacle enclosing an adapted, removable, reusable, closure-capped polymer Bottle, said Receptacle comprising a single walled, cylindric, hollow, first end open, second end closed, integrally ribbed inwardly vertically, outer formed Body, united with an adapted, hollow, single walled, flat based, shorter Upper Cup, said Bottle being a blow moulded, narrow neck threaded, horizontally outwardly ribbed Bottle closed with an adapted, top flat, reusable, threaded Closure Cap, said closure-capped Bottle being stored in a standing, base resting, body mostly spaced apart, top kept down by said Body secured said Upper Cup, horizontal movement restrained manner, said Bottle's maximum external width being less than least internal widths of said Body and said Upper Cup, said Receptacle being fully opaque with incorporated or applied reflectivity or, fully clear, said Body taking alternatively to said Bottle's base to upright body end, an upright, standard 12 oz can, said Receptacle alternatively taking within its inner height limits, an upright can of width similar to said 12 oz can but taller.

2. A standable Receptacle as claimed in claim 1, wherein a longer Body and a shorter Upper Cup unite to form said Receptacle, said Body and said Upper cup having adapted threads on their open ends for mutual but limited mating, the mating ensuing inner form being sufficient to enclose securely an adapted, closure-capped Bottle, said stored Bottle being base rested and kept down by top of said secured Closure Cap by said Body's inner base and said Body secured said Upper Cup's inner base respectively, said Receptacle's inner being mostly spaced apart from said stored Bottle.

3. A specifically shaped, sized, closure-capped polymer Bottle meant to be stored within an adapted Receptacle, as claimed in claim 1, said Bottle having a first, narrowest, open neck end, a widening shoulder, an upright, horizontally outwardly ribbed body and a closed base, said Bottle so sized that said closure-capped Bottle's total height is just sufficient to allow it to be stored securely within an adapted Receptacle, and said Bottle so shaped that said base and said ribbed body portion will be inside the longer Body part of said Receptacle and said narrowing shoulder and said narrowest neck will be within the said Body attached shorter Upper Cup part of said Receptacle.

4. The Body of a Receptacle as claimed in claims 1 and 2, said Body's open end's outer having top down threads to take an adapted Upper Cup, and below said threads, shaped, vertical grooves till base, said Body having integral, inward, vertical ribs, said inward ribs mostly spacing apart said storing Body's inner from stored Bottle's upright portion, and said Body having a holding strap or holding handle.

5. An Upper Cup as claimed in claims 1 and 2, said Upper Cup having a flat sided base with a depending down sided wall, said wall end having a depending, outward, horizontal, flat ring, said ring end having a downward depending, internally threaded skirt for mating with the Body, said flat ring limiting said mating of said Cup to said Body, said Upper Cup on being secured to said Body, having its said base's inner kissing the top of said Body seated Bottle secured Closure Cap.

6. The combinational result of two sets of opposite facing, different direction ribs within an Insulated Bottle device, one set on the Receptacle's Body's inner and the second set on the outer body of the adapted Bottle stored within said Body, as claimed in claim 1, said ribs of said Body going inwardly but being vertical, and of said Bottle going outwardly but being horizontal, thus the said opposing ribs restraining the horizontal movement of said stored Bottle, creating an air jacket around said stored Bottle for improved insulation, and improving impact safety of said stored Bottle.
